(19) United States
(12) Patent Application Publication
(10) Pub. No.: US 2013/0248110 A1
(43) Pub. Date: Sep. 26, 2013

(54) SEALING COMPOSITION AND METHOD FOR MANUFACTURING DISPLAY PANEL USING THE SAME

(71) Applicant: SAMSUNG DISPLAY CO., LTD., Yongin-city (KR)

(72) Inventors: Ki-Beom LEE, Seoul (KR); Hyang-Shik Kong, Seongnam-si (KR); Hyun-Seok Kim, Anyang-si (KR); Sung Hee Lee, Seoul (KR); Seung-Jun Lee, Yongin-si (KR); Jae-Hyuk Chang, Seongnam-si (KR); Gug-Rae Jo, Asan-si (KR)

(73) Assignee: Samsung Display Co., Ltd., Yongin-city (KR)

(21) Appl. No.: 13/762,015

(22) Filed: Feb. 7, 2013

(30) Foreign Application Priority Data
Mar. 20, 2012 (KR) 10-2012-0028090

(51) Int. Cl. C09J 163/00

(52) U.S. Cl. CPC C09J 163/00
USPC 156/330; 522/33; 522/39; 522/44; 522/53; 522/48; 522/47; 522/69; 522/64; 522/46; 522/68

(57) ABSTRACT

A sealing composition and a method of manufacturing a display panel using the sealing composition are disclosed. The sealing composition includes about 10% by weight to about 80% by weight of a denatured epoxy resin having a methacrylate group, about 5% by weight to about 40% by weight of a photo-curing acrylate monomer, about 1% by weight to about 10% by weight of a heat-curing agent, about 1% by weight to about 10% by weight of a photo-polymerization initiator, about 5% by weight to about 50% by weight of a filler, about 1% by weight to about 10% by weight of a flexibility improving agent and about 0.001% by weight to about 8% by weight of an additive.

### CROSS REFERENCE TO RELATED APPLICATION

This application claims priority from and the benefit of Korean Patent Application No. 10-2012-0028090, filed on Mar. 20, 2012, which is hereby incorporated by reference for all purposes as fully set forth herein.

### BACKGROUND

1. Field

Exemplary embodiments of the present invention relate to a sealing composition and a method of manufacturing a display panel using the sealing composition. Exemplary embodiments of the present invention also relate to a sealing composition to form a sealing member having flexibility according to a flexible display apparatus and a method of manufacturing the display panel using the sealing composition.

2. Discussion of the Background

A flat panel display (FPD) may be used as a display apparatus. The flat panel display may be a large, thin and/or light weight display device. Examples of flat panel display include, but are not limited to, a liquid crystal display (LCD), a plasma display panel (PDP) and an organic light emitting display (OLED).

Conventional displays may use a glass substrate, which has a low flexibility. Thus, applications for conventional displays may be limited.

Recently, instead of a glass substrate, a substrate of a flexible material, such as a plastic, or a foil has been developed to be used for manufacturing a flexible display apparatus.

Usually in a process for manufacturing a display apparatus, a pixel array is formed on a surface of a first substrate, and the first substrate is combined with a second substrate by using a sealing member or an enveloping member to seal the pixel array.

However, a sealing member formed from a conventional sealing composition may not have flexibility. When the sealing member is used for a flexible display apparatus, the sealing member may reduce the flexibility of the flexible display apparatus.

### SUMMARY OF THE INVENTION

Exemplary embodiments of the present invention provide a sealing composition to form a sealing member, to increase the flexibility of a flexible display apparatus.

Exemplary embodiments of the present invention also provide a method of manufacturing a display panel using the sealing composition.

Additional features of the invention will be set forth in the description which follows, and in part will be apparent from the description, or may be learned by practice of the invention.

Exemplary embodiments of the present invention provide a sealing composition including about 10% by weight to about 40% by weight of a denatured epoxy resin comprising a methacrylate group, about 10% by weight to about 40% by weight of a photo-curing acrylate monomer, about 1% by weight to about 10% by weight of a heat-curing agent, about 1% by weight to about 10% by weight of a photo-polymerization initiator, about 10% by weight to about 50% by weight of a filler, about 1% by weight to about 10% by weight of a flexibility improving agent, and about 10% by weight to about 30% by weight of a solvent.

Exemplary embodiments of the present invention also provide a method of manufacturing a display panel. The method includes disposing an array substrate having a pixel array, providing a sealing composition comprising about 10% by weight to about 40% by weight of a denatured epoxy resin having a methacrylate group, about 10% by weight to about 40% by weight of a photo-curing acrylate monomer, about 1% by weight to about 10% by weight of a heat-curing agent, about 1% by weight to about 10% by weight of a photo-polymerization initiator, about 10% by weight to about 50% by weight of a filler, about 1% by weight to about 10% by weight of a flexibility improving agent and about 10% by weight to about 30% by weight of a solvent, disposing an opposing substrate on the array substrate for contacting the sealing composition, and curing the sealing composition.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1, FIG. 2, FIG. 4 and FIG. 5 are cross-sectional views illustrating a method of manufacturing a display panel according to exemplary embodiments of the present invention.

FIG. 3 is a perspective view illustrating a method of manufacturing a display panel according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It may also be understood that for the purposes of this disclosure, “at least one of X, Y, and Z” or “at least one selected from the group consisting of X, Y and Z” can be construed as X only, Y only, Z only, or any combination of two or more items X, Y, and Z (e.g., XYZ, XYY, YZ, ZZ).

Hereinafter, exemplary embodiments of the present invention are described in detail with reference to the accompanying drawings.

A sealing composition may include a denatured epoxy resin having a methacrylate group, a curing agent, a photo-polymerization initiator, an inorganic filler, a flexibility improving agent, and an additive. Herein, all weight percentages are based on the total weight of the sealing composition.

For example, the sealing composition may include about 10% by weight to about 80% by weight of a denatured epoxy resin having a methacrylate group, about 5% by weight to about 40% by weight of a photo-curing acrylate monomer, about 1% by weight to about 10% by weight of a heat-curing agent, about 1% by weight to about 10% by weight of a photo-polymerization initiator, about 10% by weight to about 50% by weight of a filler, about 1% by weight to about 10% by weight of a flexibility improving agent, and about 10% by weight to about 30% by weight of a solvent. The sealing composition may further include about 0.001% by weight to about 8% by weight of an additive. For example, the sealing composition may further include about 0.5% by weight to about 8% by weight of a thixotropy controlling agent and about 0.01% by weight to about 1% by weight of a silane coupling agent.

The denatured epoxy resin having a methacrylate group may serve as a binder in the sealing composition. The denatured epoxy resin having a methacrylate group may have a methacrylate group and an epoxy group. The denatured epoxy resin may react with both the photo-curing acrylate monomer and the heat-curing agent.

Examples of the denatured epoxy resin having a methacrylate group include a bisphenol A-based epoxy resin, a bisphenol F-based epoxy resin, a novolac-based epoxy resin, a brominated epoxy resin, a cycloaliphatic-based epoxy resin, a rubber-based epoxy resin, an aliphatic polyglycidyl-based epoxy resin, a glycidyl amine-based epoxy resin, a biphenyl-based epoxy resin, a naphthalene-based epoxy resin, and a tris-phenol methane-based epoxy resin. The epoxy resins may be used alone or in any combination.

The denatured epoxy resin having a methacrylate group may include resins of the YD-128 Series, the YDF-170 Series, the YDB Series, the YDCN Series, the YH-434 Series, the YD-171 Series, YD-128, YD-115, YDC-1312, YLSV-80XY, YLSV-120TE, KSR-177, KSR-176×90, and KSR-276M70.

When an amount of the denatured epoxy resin having a methacrylate group is less than about 10% by weight, based on the total weight of the sealing composition, forming a coating layer having a sufficient thickness may be difficult. When an amount of the denatured epoxy resin having a methacrylate group is greater than about 40% by weight, based on the total weight of the sealing composition, having a proper viscosity may be difficult. Thus, an amount of the denatured epoxy resin having a methacrylate group may be about 10% by weight to about 40% by weight, based on the total weight of the sealing composition.

The photo-curing acrylate monomer may react with the denatured epoxy resin having the methacrylate group by light-exposure. The sealing composition may then be cured.

Examples of the photo-curing acrylate monomer include dipentaerythritol hexaacrylate, dicyclopentadiene acrylate, dicyclopentadiene methacrylate, trimethylpropane triacrylate, glycidyl methacrylate, diethylene glycol dimethacrylate, ethylene glycol acrylate, and ethylene glycol dimethacrylate. These acrylates may be used alone or in a combination.

When an amount of the photo-curing acrylate monomer is less than about 10% by weight, based on the total weight of the sealing composition, photo-curing of the coating layer may not be sufficiently performed. The stability of a coating layer may be decreased. When an amount of the photo-curing acrylate monomer is greater than about 40% by weight, based on the total weight of the sealing composition, the flexibility of a coating layer may be decreased. Thus, an amount of the photo-curing acrylate monomer may be about 10% by weight to about 40% by weight, based on the total weight of the sealing composition.

The heat-curing agent may react with the denatured epoxy resin having a methacrylate group when heated. The sealing composition may then be cured.

Examples of the heat-curing agent include an amine curing agent, an acid anhydride curing agent, and an imidazole curing agent. The heat-curing agent may be selected according to a temperature of the heat-curing process.

Examples of the heat-curing agent include diamino diphenyl methane (DDM), diamino diphenyl sulfone (DDS), tetrahydrophthalic anhydride (THPA), hexahydrophthalic anhydride (HHPA), methyltetrahydrophthalic anhydride (MeTHPA), nadic methyl anhydride (NMA), hydrolized methylnadic anhydride (HNMA), phthalic anhydride (PA), 2-phenyl-4-methyl-hydroxymethylimidazole, 3-(3,4-dichlorophenyl)-1,1-dimethylurea (DCMU), a sulfonium salt, a phosphonium salt, a biphenyl ether block carbonic acid, an activated ether of polycabonic acid, 1-cyanoethyl 2-phenyl imidazole (TCI), 1,1-dimethoxy-N,N-dimethyl methanamine, 1-phenylethylamine, 2-(diethoxylamino)ethylamine, 2-phenylethylamine, 3-methoxypropylamine, butylamine, cyclohexylamine, 1-phenylpropylamine, di(2-ethylhexyl)amine, dibutylamine, diethylamine, diethylenetriamine, dimethylethylamine, dipropylamine, dipropylene triamine, isopropylamine, N,N-bis-(3-aminopropyl)methylamine, N,N-dimethylisopropylamine, N-ethyldiisopropylamine, N-octylamine, N-3-amine-3-(2-aminoethylamino)propylamine, propylamine, tributylamine, tripropylamine, tris-(2-ethylhexyl)amine, tert-butylamine, diisopropanolamine, methyldiethanolamine, N,N-dimethylisopropanolamine, N-methylethalonamine, 2,6-xylidine, N-ethyl-N-(2-hydroxyethyl)aniline, ethylenediamine, isophorone diamine, ethylethanolamine, N-(2-aminoethyl)ethanolamine, triisopropanolamine, diethylenetriamine, ethylenediamine, N-(2-aminethyl)ethanolamine, 1-methoxylimidazole, 1-vinylimidazole, N,N-dimethylisopropanolamine, N-ethyl-N-(2-hydroxyethyl)aniline, 1-methylimidazole, N,N-dimethylcyclohexylamine, and trimethylaminoethylethanolamine.

When an amount of the heat-curing agent is less than about 1% by weight, based on the total weight of the sealing composition, the stability of a coating layer may be decreased. When an amount of the heat-curing agent is greater than about 10% by weight, based on the total weight of the sealing composition, the flexibility of a coating layer may be decreased. Thus, an amount of the heat-curing agent may be about 1% by weight to about 10% by weight, based on the total weight of the sealing composition.

The photo-polymerization initiator may be decomposed by light to form a radical. The photo-polymerization initiator may serve to activate photo-polymerization of the photo-curing acrylate monomer.

Examples of the photo-polymerization initiator include a benzoin compound, an acetophenone compound, a diethoxy acetophenone compound, a hydroxylacetophoenone compound, a benzophenone compound, a thioxanthone compound, an anthraquinone compound, an á-acyloxim ester compound, a phenyl glyoxylate compound, a benzyl compound, an azo compound, a diphenyl sulphide compound, an acylphosphine oxyl compound, an organic pigment compound, and an iron-phthalocyanine compound. These compounds may be used alone or in a combination.

Other examples of the photo-polymerization initiator include 1-phenyl-2-hydroxy-2-methyl propane-1-one, 1-hydroxy cyclohexyl phenyl ketone, amino acetophenone, benzyl dimethyl ketal, benzoin ether, thioxanthone, 2-ethylanthraquinone (2-ETAQ), camphorquinone, á-naphtol, 2,4-diethylthioxanthone, trimethylbenzoyl diphenylphosphine oxide, benzophenone, and 2,2-diethoxyacetophenone, and benzoilisopropyl ether.

Other examples of the photo-polymerization initiator include Irgacure 149, Irgacure 184, Irgacure 369, Irgacure 379, Irgacure 500, Irgacure 651, Irgacure 784, Irgacure 819, Irgacure 907, Irgacure 1700, Irgacure 1800, Irgacure 1850, Irgacure 2959, Irgacure1173, Darocur 1173, Darocur 4265, and Irgacure OXE02.

When an amount of the photo-polymerization initiator is less than about 1% by weight based on the total weight of the sealing composition, photo-curing may not be performed. When an amount of the photo-polymerization initiator is greater than about 10% by weight, based on the total weight of the sealing composition, the flexibility of a coating layer may decrease. Thus, an amount of the photo-polymerization initiator may be about 1% by weight to about 10% by weight, based on the total weight of the sealing composition.

The filler may prevent softening of a sealing member, which may occur when the sealing composition is heated. The filler may serve as a supporting member in the sealing member.

The filler may include an organic filler and/or an inorganic filler. Examples of the organic filler may include poly methylmethacrylate, polystyrene and a copolymer of monomer capable of copolymerization.

Examples of the inorganic filler include potassium carbonate, magnesium carbonate, barium sulfate, magnesium sulfate, iron oxide, titanium dioxide, zinc oxide, aluminum oxide, aluminum silicate, silicon dioxide, asbestos dust, quartz powder, glass fiber, mica, silica, diatomite, tin oxide, magnesium hydroxide, aluminum hydroxide, magnesium carbonate, gypsum, calcium silicate, talc, glass bead, sericite, activated clay, bentonnite, aluminum nitride, silicon nitride, potassium titanate, zeolite, calcia, magnesia, ferrite, zerolite, aluminum stearate, and aluminum hydroxide. The inorganic fillers may be used alone or in a combination.

When the sealing composition includes the inorganic filler, the inorganic filler may be preferred to have a uniform particle size. A maximum diameter of the inorganic filler particle may be less than 5 μm. When a particle size of the inorganic filler is greater than 5 μm, a cell gap of a display panel combined by the sealing composition may not be uniform.

When an amount of the filler is less than about 10% by weight based on the total weight of the sealing composition, substrate attachment stability may be decreased. When an amount of the filler is greater than about 50% by weight, based on the total weight of the sealing composition, flexibility may decrease and a cell gap of the display panel may not be uniform. Thus, the amount of the filler may be about 10% by weight to about 50% by weight, based on the total weight of the sealing composition.

The flexibility improving agent may serve to increase the flexibility of a sealing member formed from the sealing composition.

Examples of the flexibility improving agent include a thermo-plastic resin, a phenoxy resin, an elastomer, a reactive rubber, and a denatured epoxy resin organic elastomer.

Examples of the reactive thermo-plastic resin include polyethylene, polypropylene, polyvinyl acetate, polystyrene, an acrylonitrile butadiene styrene (ABS) resin, and an acrylic resin.

Examples of the elastomer include polyisoprene, polyisobutylene, polybutadiene, polyvinyl chloride, polyurethane, and polysiloxane.

Examples of the reactive rubber include carboxylic acrylonitrile-butadiene rubber (xNBR), carboxyl-terminated butadiene acrylonitrile (CTBN), nitrile butadiene rubber, cis-isoprene rubber, and styrene butadiene rubber (SBR).

The denatured epoxy resin organic elastomer may have an epoxy group and an acrylate group. The weight-average molecular weight of the organic elastomer may be about 5,000 to about 25,000 grams per mole.

Examples of the flexibility improving agent include the elastomer polyisoprene, polyisobutylene, polybutadiene, polyvinyl chloride, polyurethane, and polysiloxane. A weight-average molecular weight of the flexibility improving agent may be about 5,000 to about 50,000 grams per mole.

When an amount of the flexibility improving agent is less than about 1% by weight, based on the total weight of the sealing composition, the flexibility of a sealing member may be poor. When an amount of the flexibility improving agent is greater than about 10% by weight, based on the total weight of the sealing composition, flexibility may excessively be increased, so that a stable combination of substrates may be difficult. Thus, an amount of the flexibility improving agent may be about 1% by weight to about 10% by weight, based on the total weight of the sealing composition.

Examples of the thixotropy controlling agent include methyl cellulose, methyl ethyl ketone peroxide, oxidized polyethylene-wax, denatured polypropylene emulsion, polyamide wax, organic clay, alkyl sulfate, hydroxyl ethyl cellulose, hydroxyl acid esters, polyvinyl alcohol, polydimethyl siloxane, unsaturated carboxylic acid monomer, hydroxide carboxylic acid amide, ethylene glycol, diethylene glycol, triethylene glycol, alkali earth metal hydroxide, and alkali earth metal carbonate. The thixotropy controlling agents may be used alone or in a combination.

Examples of the silane coupling agent include any suitable conventional silane coupling agents.

The solvent controls the viscosity of the sealing composition. Examples of the solvent may include N-methyl-2-pyrrolidone, gamma butyl lactone, butyl cellulose, propylene glycol monomethyl ether acetate, isopropyl acetate, butyl acetate, ethanol, and ethyl lactate.

When an amount of the solvent is less than about 10% by weight based on the total weight of the sealing composition, the viscosity of the sealing composition may excessively increase, such that the uniformity of the sealing member may be decreased. When an amount of the solvent is greater than about 30% by weight, based on the total weight of the sealing composition, achieving a proper thickness of the sealing member may be difficult. Thus, an amount of the solvent may be 10% by weight to about 30% by weight based on the total weight of the sealing composition.

According to exemplary embodiments of the present invention, a sealing member having flexibility may be formed. The sealing member having flexibility may improve the flexibility of a flexible display apparatus. When thermal expansion coefficients of two substrates in a display panel are different, temperature changes may lead to volume variations between the substrates. The sealing member having flexibility may effectively manage the difference between volume variations of the substrates, so that reliability of the display panel is improved.

A method of forming a display panel using the sealing composition according to exemplary embodiments of the present invention will be described in detail with reference to the accompanying drawings.

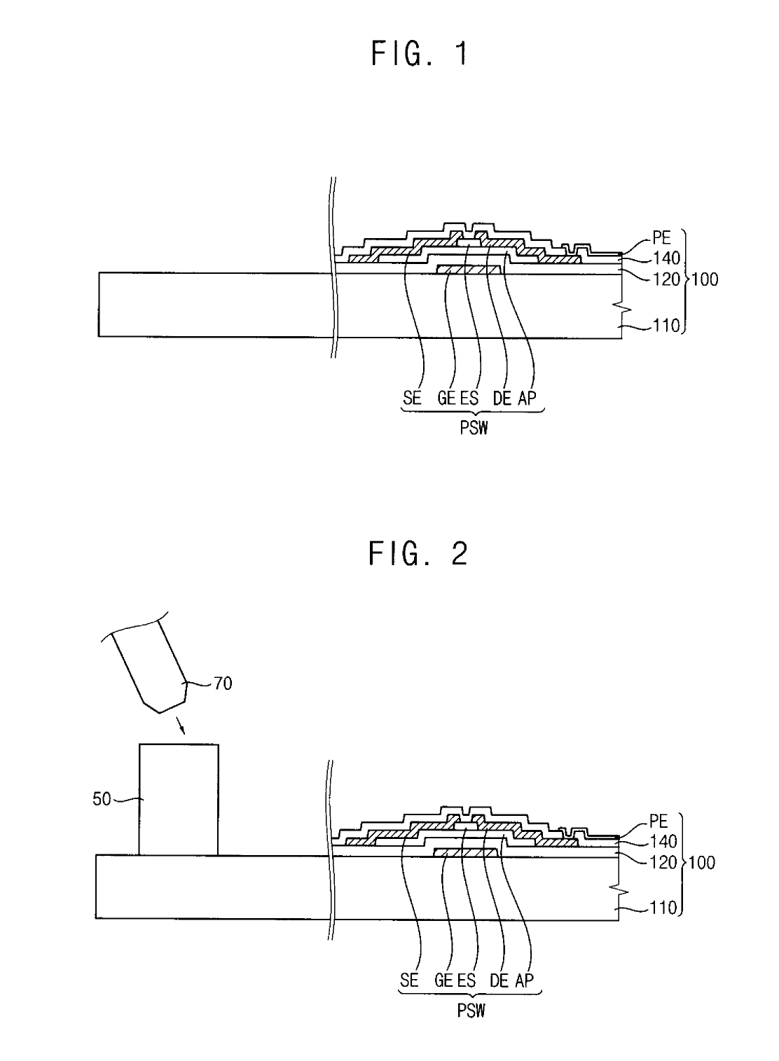

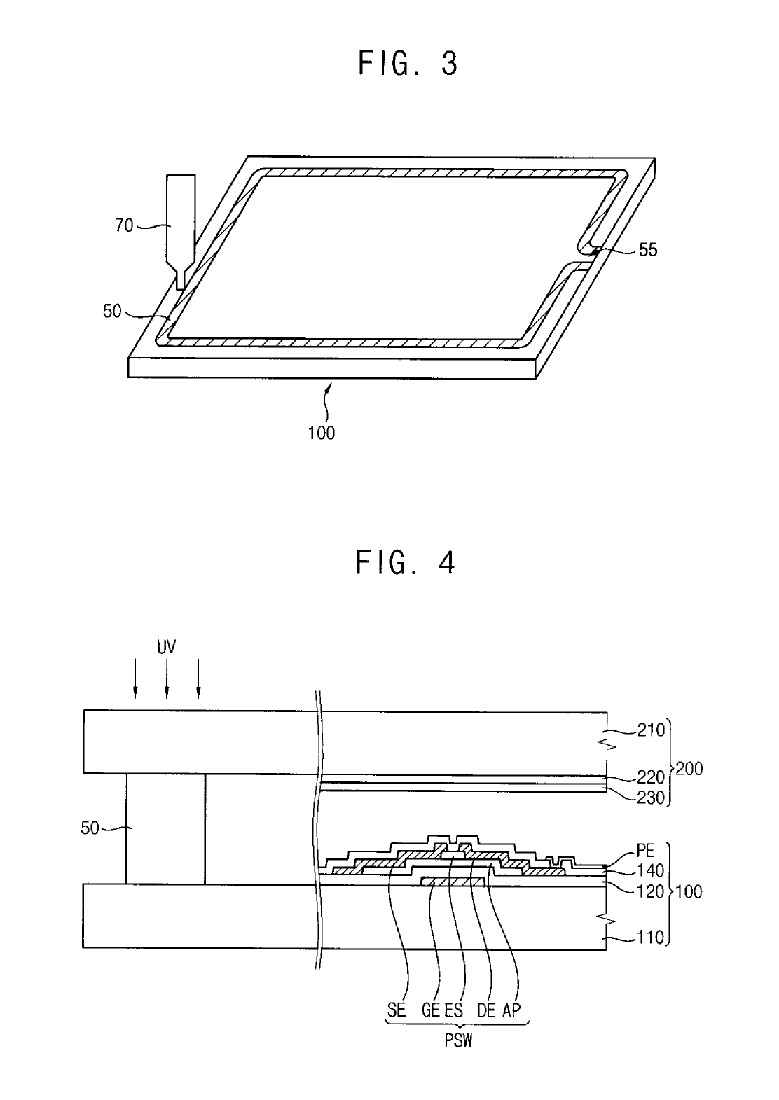

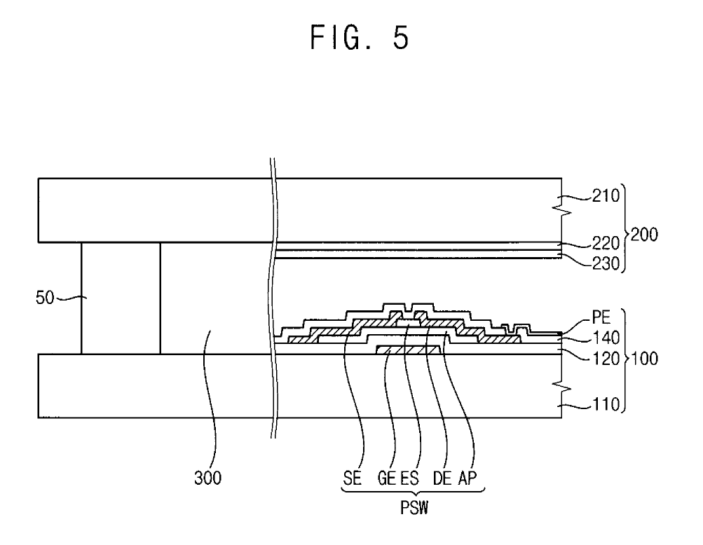

FIG. 1, FIG. 2, FIG. 4 and FIG. 5 are cross-sectional views illustrating a method of manufacturing a display panel, according to exemplary embodiments of the present invention. FIG. 3 is a perspective view illustrating a method of manufacturing a display panel according to exemplary embodiments of the present invention.

Referring to FIG. 1, a pixel array may be formed on a base substrate 110 to form an array substrate 100. The pixel array may include a pixel transistor PSW and a pixel electrode PE connected to the pixel transistor PSW.

For example, the base substrate 110 may be a flexible substrate including a polymer. The base substrate 110 may include Kapton, polyethersulphone (PES), polycarbonate (PC), polyimide (PI), polyethyleneterephthalate (PET), polyethylenenaphthalate (PEN), polyacrylate (PAR), and fiber reinforced plastic (FRP). The polymers may be used alone or in a combination.

If the base substrate 110 is a plastic substrate, the plastic substrate may have a large flexibility as compared to, for example, a glass substrate or a soda-lime substrate, such that a problem such as slack is caused. Thus, stability of a process may decrease. The base substrate 110 may include a glass substrate as a carrier substrate and a polymer layer formed on the glass substrate. The pixel array may be formed on the polymer layer. When the base substrate 110 includes a carrier substrate such as the glass substrate, after the pixel array is formed on the polymer layer, or after manufacturing a panel is completed, the carrier substrate may be removed such that the polymer layer serves as a flexible substrate.

The pixel transistor PSW may include a gate electrode GE, which may be connected to a gate line, a source electrode SE which may be connected to the data line DL, a drain electrode DE, which may be spaced apart from the source electrode SE, and a semiconductor pattern AP.

The semiconductor pattern AP may be overlapped with the gate electrode GE, and may be disposed, at least in part, on the gate electrode GE. The semiconductor pattern AP may include an oxide. A transistor using an oxide semiconductor may be formed at a low temperature. Thus, the transistor may be used for manufacturing a plastic array substrate. The semiconductor pattern AP may include amorphous silicon, or polycrystalline silicon.

For example, the semiconductor pattern AP may include indium oxide, zinc oxide, tin oxide or gallium oxide. The semiconductor pattern AP may include a multi-component semiconductor such as indium-zinc oxide or indium-zinc-gallium oxide.

The semiconductor pattern AP may further include a dopant such as lithium (Li), sodium (Na), potassium (K), rubidium (Rb), cesium (Cs), beryllium (Be), magnesium (Mg), calcium (Ca), strontium (Sr), aluminum (Al), barium (Ba), titanium (Ti), zirconium (Zr), hafnium (Hf), vanadium (V), yttrium (Y), niobium (Nb), tantalum (Ta), chromium (Cr), molybdenum (Mo), tungsten (W), manganese (Mn), technetium (Tc), rhenium (Re), iron (Fe), ruthenium (Ru), osmonium (Os), cobalt (Co), rhodium (Rh), iridium (Ir), nickel (Ni), palladium (Pd), platinum (Pt), copper (Cu), silver (Ag), gold (Au), cadmium (Cd), mercury (Hg), boron (B), gallium (Ga), indium (In), thallium (Tl), silicon (Si), germanium (Ge), tin (Sn), lead (Pb), phosphorus (P), arsenic (As), bismuth (Bi), lanthanum (La), cerium (Ce), gadolinium (Gd), neodymium (Nd), tellurium (Te), scandium (Sc), polonium (Po), praseodymium (Pr), terbium (Tb), dysprosium (Dy), holmium (Ho), europium (Eu), erbium (Er) and/or ytterbium (Yb). The dopants may be used alone or in a combination.

The semiconductor pattern AP may be formed through a solution process using a composition or a chemical vapor deposition (CVD).

Each of the source electrode SE and the drain electrode DE may be formed on the semiconductor pattern AP. The semiconductor pattern AP may be damaged by an etchant or a strip solution in the process of forming the source electrode SE and the drain electrode DE. Thus, a first etch stopper ES may be formed on the semiconductor pattern AP such that the semiconductor pattern AP may be prevented from being exposed through a gap between the source electrode SE and the drain electrode DE. The source electrode SE and the drain electrodes DE may be partially formed on the first etch stopper ES. However, the first etch stopper ES may be omitted depending on constitution and forming process of an oxide semiconductor.

The source electrode SE may be overlapped with a first end portion of the semiconductor pattern AP. The drain electrode DE may be overlapped with a second end portion of the semiconductor pattern AP. A contact resistance between the semiconductor pattern AP and the source electrode SE and in between the semiconductor pattern AP and the drain electrode DE may be lower than when the semiconductor pattern has an amorphous silicon semiconductor. Thus, an ohmic contact layer may not be formed. However, in some cases, an additional ohmic contact layer (not illustrated) may be formed to minimize contact resistance.

The drain electrode DE may make contact with the pixel electrode PE, so that the pixel transistor PSW may be electrically connected to the pixel electrode PE.

The base substrate 110 may further include a gate insulating layer 120 and a passivation layer 140. The gate insulating layer 120 may be formed on the base substrate 110 including the gate electrode GE.

The gate insulating layer 120 may include a nitride layer and/or an oxide layer. The passivation layer 140 may be formed on the source electrode SE and the drain electrode DE. Examples of a material that may be used for the passivation layer 140 include a nitride, an oxide, and an oxynitride.

The pixel electrode PE may be formed on the passivation layer 140. The pixel electrode PE may directly contact the drain electrode DE through a contact hole formed through the passivation layer 140. The pixel electrode PE may include transparent conductive oxide. Examples of a material that may be used for the pixel electrode PE include indium tin oxide (ITO), and indium zinc oxide (IZO).

Referring to FIG. 2 and FIG. 3, a sealing composition may be coated by a dispenser 70 in a peripheral area of the array substrate 100 to form a sealing line 50.

The sealing composition may contact the base substrate 110. In some cases, the gate insulating layer 120 may not be removed in the peripheral area such that the gate insulating layer 120 remains. Thus, the sealing composition may be provided on the gate insulating layer 120.

The sealing line 50 may represent a shape surrounding a display area formed by the pixel array, and may include a liquid crystal inlet 55 formed at a side. A liquid crystal may be injected through the liquid crystal inlet 55 after combination of the substrates.

The sealing composition may include about 10% by weight to about 40% by weight of a denatured epoxy resin having a methacrylate group, about 10% by weight to about 40% by weight of a photo-curing acrylate monomer, about 1% by weight to about 10% by weight of a heat-curing agent, about 1% by weight to about 10% by weight of a photo-polymerization initiator, about 10% by weight to about 50% by weight of a filler, about 1% by weight to about 10% by weight of a flexibility improving agent and about 10% by weight to about 30% by weight of a solvent. The sealing composition may also include a flexibility improving agent and about 0.001% by weight to about 8% by weight of an additive, about 0.5% by weight to about 8% by weight of a thixotropy controlling agent and about 0.01% by weight to about 1% by weight of a silane coupling agent.

The sealing composition may substantially be the same as the previously explained sealing composition. Duplicated description of the sealing composition will be omitted.

Referring to FIG. 4, an opposing substrate 200 may be disposed on the array substrate 100 to contact the sealing line 50, and light may be irradiated into the sealing line 50 to cure the sealing line to form a sealing member 50. The array substrate 100 and the opposing substrate 200 may be combined.

The sealing composition may contact a base substrate 210 of the opposing substrate 200. In some cases, a common electrode 230 may not be removed in the peripheral area such that, the common electrode 230 remains. Thus, in some cases, the sealing composition may contact the common electrode 230.

For example, when ultraviolet light is irradiated into the sealing line 50, a photo-polymerization may be generated by a photo-polymerization initiator, and the denatured epoxy resin having a methacrylate group and the photo-curing acrylate monomer may react to form cross-link. Thus, the sealing composition may be cured.

Thereafter, the sealing member 50 may be heated to induce heat-curing. Heating temperature may be about 110° C. to about 170° C. When the sealing member 50 is heated, the heat-curing agent and the denatured epoxy resin having a methacrylate group may react to form cross-links. Thus, the sealing member 50 is secondarily cured.

The sealing member 50 may serve to increase the flexibility of display panel. The denatured epoxy resin having a methacrylate group and an epoxy group in the sealing composition may be photo-cured with the photo-curing acrylate monomer, and may be heat-cured with the heat-curing agent. Thus, the stability of the sealing member 50 may be improved.

The opposing substrate 200 may include a base substrate 210, a color filter layer 220 formed on the base substrate 210 and a common electrode 230. The common electrode 230 may be formed on the color filter layer 220 to face the pixel array. Even though not illustrated, the opposing substrate 200 may also include an over-coating layer for compensating a step difference, and a black matrix. In some cases, the color filter layer 220 and/or the common electrode 230 may be formed on the array substrate 100.

The base substrate 210 may be a plastic substrate similar to base substrate 110 of the array substrate 100. Examples of a material that may be used for the base substrate 210 may include Kapton, polyethersulphone (PES), polycarbonate (PC), polyimide (PI), polyethyleneterephthalate (PET), polyethylenenaphthalate (PEN), polyacrylate (PAR), and fiber reinforced plastic (FRP). In some cases, the base substrate 210 may include a substrate such as glass substrate, including a material different from the base substrate 110 of the array substrate 100.

When two substrates of the display panel include different materials, volume changes of the substrates may be different from coefficient difference of thermal expansion. However, the sealing member 50 formed may include flexibility to compensate the difference of the volume changes. Thus, a weak combination of the two substrates, and a decrease of reliability of display panel may be prevented.

Referring to the FIG. 5, after forming the sealing member 50, a liquid crystal may be injected through a liquid crystal inlet 55. The liquid crystal layer 300 may be formed between the array substrate 100 and the opposing substrate 200. The liquid crystal may be injected, and the liquid crystal inlet 55 may be sealed.

In exemplary embodiments of the present invention, a method of manufacturing a liquid crystal display apparatus is described. However, the sealing composition of the present invention may be used for manufacturing of other flexible display apparatus as well, such as an organic light-emitting diode (OLED) display apparatus.

For example, when the sealing composition is used for manufacturing of an organic light-emitting diode (OLED) display apparatus, the sealing composition may be used for forming of an enveloping member. The enveloping member may not have a shape of line, and may be widely formed on a surface of an array substrate.

The sealing composition may be used for manufacturing of a display apparatus such as a liquid crystal display apparatus, and an organic light-emitting diode (OLED) display apparatus.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A sealing composition comprising, based on a total weight of the sealing composition:
about 10% by weight to about 40% by weight of a denatured epoxy resin comprising a methacrylate group;
about 10% by weight to about 40% by weight of a photo-curing acrylate monomer;
about 1% by weight to about 10% by weight of a heat-curing agent;
about 1% by weight to about 10% by weight of a photo-polymerization initiator;
about 10% by weight to about 50% by weight of a filler;
about 1% by weight to about 10% by weight of a flexibility improving agent; and
about 10% by weight to about 30% by weight of a solvent.

2. The sealing composition of claim 1, wherein the denatured epoxy resin comprises at least one resin selected from the group consisting of a bisphenol A-based epoxy resin, a bisphenol F-based epoxy resin, a novolac-based epoxy resin, a brominated epoxy resin, a cycloaliphatic-based epoxy resin, a rubber modified-based epoxy resin, an aliphatic polyglycidyl-based epoxy resin, a glycidyl amine-based epoxy resin, a biphenyl-based epoxy resin, a naphthalene-based epoxy resin and a tris-phenol methane-based epoxy resin.

3. The sealing composition of claim 1, wherein the a photo-curing acrylate monomer comprises at least one acrylate selected from the group consisting of dipentaerythritol hexaacrylate, dicyclopentadiene acrylate, dicyclopentadiene methacrylate, trimethylpropane triacrylate, glycidyl methacrylate, diethylene glycol dimethacrylate, ethylene glycol acrylate, and ethylene glycol dimethacrylate.

4. The sealing composition of claim 1, wherein a heat-curing agent comprises at least one compound selected from the group consisting of diamino diphenyl methane (DDM), diamino diphenyl sulfone (DDS), tetrahydrophthalic anhydride (THPA), hexahydrophthalic anhydride (HHPA), methyltetrahydrophthalic anhydride (MeTHPA), nadic methyl anhydride (NMA), hydrolized methylnadic anhydride (HNMA), phthalic anhydride (PA), 2-phenyl-4-methyl-hydroxymethylimidazole, 3-(3,4-dichlorophenyl)-1,1-dimethylurea (DCMU), a sulfonium salt, a phosphonium salt, a biphenyl ether block carbonic acid, an activated ether of polycabonic acid, 1-cyanoethyl-2-phenyl imidazole (TCI), 1,1-dimethoxy-N,N-dimethyl methanamine, 1-phenylethylamine, 2-(diethoxylamino)ethylamine, 2-phenylethylamine, 3-methoxypropylamine, butylamine, cyclohexylamine, 1-phenylpropylamine, di(2-ethylhexyl)amine, dibutylamine, diethylamine, diethylenetriamine, dimethylethylamine, dipropylamine, dipropylene triamine, isopropylamine, N,N-bis-(3-aminopropyl)methylamine, N,N-dimethylisopropylamine, N-ethyldiisopropylamine, N-octylamine, N-3-amine-3-(2-aminoethylamino)propylamine, propylamine, tributylamine, tripropylamine, tris-(2-ethylhexyl)amine, tert-butylamine, diisopropanolamine, methyldiethanolamine, N,N-dimethylisopropanolamine, N-methylethalonamine, 2,6-xylidine, N-ethyl-N-(2-hydroxyethyl)aniline, ethylenediamine, isophorone diamine, ethylethanolamine, N-(2-aminoethyl)ethanolamine, triisopropanolamine, diethylenetriamine, ethylenediamine, N-(2-aminethyl)ethanolamine, 1-methoxylimidazole, 1-vinylimidazole, N,N-dimethylisopropanolamine, N-ethyl-N-(2-hydroxyethyl)aniline, 1-methylimidazole, N,N-dimethylcyclohexylamine, and trimethylaminoethylethanolamine.

5. The sealing composition of claim 1, wherein the photo-polymerization initiator comprises at least one compound selected from the group consisting of 1-phenyl-2-hydroxy-2-methyl propane-1-one, 1-hydroxy cyclohexyl phenyl ketone, an amino acetophenone, benzyl dimethyl ketal, a benzoin ether, thioxanthone, 2-ethylanthraquinone (2-ETAQ), camphorquinone, α-naphtol, 2,4-diethylthioxanthone, trimethylbenzoyl diphenylphosphine oxide, benzophenone, 2,2-diethoxyacetophenone, and benzoilisopropyl ether.

6. The sealing composition of claim 1, wherein the filler comprises at least one compound selected from the group consisting of potassium carbonate, magnesium carbonate, barium sulfate, magnesium sulfate, iron oxide, titanium dioxide, zinc oxide, aluminum oxide, aluminum silicate, silicon dioxide, asbestos dust, quartz powder, glass fiber, mica, silica, diatomite, tin oxide, magnesium hydroxide, aluminum hydroxide, magnesium carbonate, gypsum, calcium silicate, talc, glass beads, sericite, an activated clay, bentonnite, aluminum nitride, silicon nitride, potassium titanate, zeolite, calcia, magnesia, ferrite, zerolite, aluminum stearate, and aluminum hydroxide.

7. The sealing composition of claim 6, wherein a maximum diameter of a particle of the filler is less than 5 μm.

8. The sealing composition of claim 1, wherein the flexibility improving agent comprises at least one compound selected from the group consisting of a reactive thermo-plastic resin, a phenoxy resin, an elastomer, a reactive rubber, and a denatured epoxy resin organic elastomer.

9. The sealing composition of claim 8, wherein the organic elastomer comprises at least one compound selected from the group consisting of polyisoprene, polyisobutylene, polybutadiene, polyvinyl chloride, polyurethane, and polysiloxane.

10. The sealing composition of claim 1, the sealing composition further comprises, based on the total weight of the sealing composition:
about 0.5% by weight to about 8% by weight of a thixotropy controlling agent; and
about 0.01% by weight to about 1% by weight of a silane coupling agent.

11. The sealing composition of claim 10, wherein the thixotropy controlling agent comprises at least one compound selected from the group consisting of methyl cellulose, methyl ethyl ketone peroxide, an oxidized-polyethylene-wax, a denatured-polypropylene emulsion, a polyamide-wax, an organic clay, an alkyl sulfate, a hydroxyl ethyl cellulose, a hydroxyl acid esters, a polyvinyl alcohol, a polydimethyl siloxane, an unsaturated carboxylic acid monomer, a hydroxide carboxylic acid amide, ethylene glycol, diethylene glycol, triethylene glycol, an alkali earth metal hydroxide, and an alkali earth metal carbonate.

12. The sealing composition of claim 1, wherein the solvent comprises at least one selected from the group consisting of N-methyl-2-pyrrolidone, gamma butyl lactone, butyl cellulose, a propylene glycol monomethyl ether acetate, an isopropyl acetate, a butyl acetate, ethanol, and ethyl lactate.

13. A method of manufacturing a display panel, the method comprising:
disposing a sealing composition on an array substrate having a pixel array, the sealing composition comprising, based on a total weight of the sealing composition, about 10% by weight to about 40% by weight of a denatured epoxy resin having a methacrylate group, about 10% by weight to about 40% by weight of a photo-curing acrylate monomer, about 1% by weight to about 10% by weight of a heat-curing agent, about 1% by weight to about 10% by weight of a photo-polymerization initiator, about 10% by weight to about 50% by weight of a filler, about 1% by weight to about 10% by weight of a flexibility improving agent, and about 10% by weight to about 30% by weight of a solvent;
attaching an opposing substrate to the array substrate using the sealing composition; and
curing the sealing composition.

14. The method of claim 13, wherein:
the array substrate comprises a base substrate upon which the pixel array is disposed; and
at least one of the base substrate and the opposing substrate is flexible.

15. The method of claim 14, wherein the base substrate and the opposing substrate comprise at least one compound selected from the group consisting of Kapton, a polyethersulphone (PES), a polycarbonate (PC), a polyimide (PI), a polyethyleneterephthalate (PET), a polyethylenenaphthalate (PEN), a polyacrylate (PAR), and a fiber reinforced plastic (FRP).

16. The method of claim 14, wherein the base substrate and the opposing substrate comprise different materials.

17. The method of claim 13, wherein the disposing of the sealing composition on the array substrate comprises applying the sealing composition to the base substrate so as to form a sealing line disposed around the pixel array.

18. The method of claim 13, wherein curing the sealing composition comprises photo-curing the sealing composition.

19. The method of claim 18, wherein curing the sealing composition further comprises heating the sealing composition to heat-curing the sealing composition.

20. The method of claim 13, wherein the flexibility improving agent comprises at least one compound selected from the group consisting of a reactive thermo-plastic resin, a phenoxy resin, an elastomer, a reactive rubber, and an organic elastomer denatured epoxy resin.
